(19) United States
(12) Patent Application Publication
(10) Pub. No.: US 2006/0275611 A1
(43) Pub. Date: Dec. 7, 2006

(54) Method of drying coating film

(75) Inventor: Hirokazu Nishimura, Odawara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/447,072

(22) Filed: Jun. 6, 2006

(30) Foreign Application Priority Data
Jun. 6, 2005 (JP) 2005-165736

(51) Int. Cl. B32B 17/06

(52) U.S. Cl. 428/426

(57) ABSTRACT

A method of drying a coating film comprises: applying a coating solution containing a solvent to a substrate transporting continuously so as to form a solvent-containing coating film; and drying the solvent-containing coating film, wherein, when the coating film includes a portion having a solvent content in a range of 20% to 45% by mass, the portion of the coating film is dried at a rate of 0.2 g/m²·s or above, and a portion of the substrate, on which the portion of the coating film is formed, is transported in a non-contact state.

### BACKGROUND OF THE INVENTION

1. Field of the Invention

The present invention relates to a method of drying a coating film that contains a solvent and, more particularly, to a method of drying a long-length and broad coating substance, such as a long-length antireflective film.

2. Description of the Related Art

In general an antireflective film is placed at the front of a display, such as a cathode-ray tube (CRT) display, a plasma display panel (PDP), an electroluminescent display (ELD) or a liquid crystal display (LCD), for the purpose of lowering the reflectance of the display on the principle of optical interference, thereby avoiding a contrast drop and reflected-image appearance by reflection of external light.

An optical film such as an antireflective film can be obtained by applying a coating solution to a continuously moving long-length substrate to form a coating film and drying the coating film. As to the methods and apparatus for drying the surface of a long-length and broad coating film, it is known not only the drying method in which the non-coated side of a substrate is supported on rollers and air from air-nozzles is made to blow on the coating surface, but also the method in which a coating surface is dried in a state that a substrate is made to float up by blowing air from air-nozzles on both non-coated and coated sides, namely the non-contact air-floating drying method in which drying is performed without contact between a substrate and rollers. Such anon-contact drying method includes the drying method using a helix-type drying apparatus as disclosed in JP-B-48-42903, wherein efficient utilization of spaces and drying with efficiency are achieved.

With respect to those methods of blowing air for drying (hereinafter referred to as “airflow drying methods”), the drying is generally performed by blowing humidity-controlled air on a coating surface to evaporate a solvent contained in the coating film. Although they are superior in drying efficiency, those airflow drying methods have a problem of failing to provide a uniform coating film. This is because air is made to blow on the coating surface directly or via a porous plate or a rectification plate and thereby the coating surface is disturbed to make the coating thickness non-uniform and to develop unevenness, and besides, the evaporation speed of the solvent at the coating surface is made uneven by convection of air to cause the so-called orange peel trouble.

The development of such unevenness is remarkable especially when the coating solution used contains an organic solvent. This is because, when the coating film at the initial stage of drying, which contains plenty of organic solvent, has an evaporation distribution of the organic solvent, the coating surface comes to have a temperature distribution and a surface tension distribution; as a result, there occurs an in-plane flow, such as the so-called Marangoni convection, in the coating film. This unevenness results in serious coating defects.

As a method for solving these problems, JP-A-2001-170547 demonstrates the system in which a zone for drying right after coating is provided. Therein is disclosed the method of preventing a coating film from developing unevenness by partitioning the zone for drying into many parts and carrying out drying in each of the partitioned parts by blowing air from one edge to the other edge in the width direction of a substrate while controlling an air velocity. In addition, JP-A-9-73016 discloses the method of placing metal gauze instead of partitioning the drying zone with the same intention.

JP-A-2001-170547 further describes the method of increasing the viscosity of a coating solution by heightening the concentration of the coating solution or adding a thickener to the coating solution in order to inhibit the coating film surface just after coating from moving by drying air, and the method of using a high boiling solvent and preventing development of unevenness through leveling effect of the high boiling solvent even if drying air causes a flow in the surface part of a coating film.

Although the methods disclosed in JP-A-2001-170547 and JP-A-9-73016 are effective in inhibiting the flow of non-uniform air from the outside of the drying zone, a great reduction of air velocity is required on condition that the air velocity should be adjusted so as not to disturb the surface of coating film. As a result, there occurs a big drop in drying speed, and for coping therewith it becomes necessary to lengthen the drying zone, which brings about reduction in coating efficiency. Even if the air velocity is greatly reduced, it is still difficult to exclude influences of the flow of air completely.

The method of heightening the viscosity of a coating solution or using a high boiling solvent, as described in JP-A-2001-170547, has problems of bringing about a loss of suitability for high-speed coating, an increase in drying time and an extreme drop in production efficiency.

In view of the fact that the airflow drying methods, especially in the case where the coating solution to be dried contains an organic solvent, pose an unevenly dried state to the coating surface in the initial drying stage, GB Patent No. 1401041, U.S. Pat. No. 5,168,639 and U.S. Pat. No. 5,694,701 disclose the methods of drying the coating surface without blowing air.

More specifically, GB Patent No. 1401041 discloses the method of drying by evaporating the solvent in a coating solution without blowing air and recovering the solvent evaporated. According to this method, an entry and exit for the passage of a substrate into and out of a casing are provided at the uppermost portion of the casing, the coating on the substrate is dried by heating the non-coated surface of the substrate inside the casing to promote the evaporation of the solvent from the coating, and the solvent evaporated undergoes condensation on a condensation plate disposed on the coating surface side and is recovered in a condensed state.

U.S. Pat. No. 5,168,639 discloses the method of recovering a solvent by using a drum set above the upper side of a substrate running in a horizontal direction, and U.S. Pat. No. 5,694,701 advances a suggestion for improving the system layout of U.S. Pat. No. 5,168,639.

However, GB Patent No. 1401041 restricts the location of substrate entry and exit to the uppermost portion of a casing and places a strong constraint on the layout of apparatus, so it is difficult to incorporate the method of GB Patent No. 1401041 into existing coating processes. In addition, the embodiment shown in FIG. 5 requires not only a measure of distance or above from coating on a substrate until the substrate entry into a recovery drier but also reversal of the base before entering into the recovery drier. Therefore, it is difficult to efficiently control the unevenness developing just after coating.

According to the method of U.S. Pat. No. 5,168,639, the distance from the coating surface to the drum for condensation and recovery of a solvent varies with the direction of coating. So it is difficult to control the drying speed uniformly over the whole region in a casing. In addition, the coating surface is needlessly distant from the drum for solvent condensation and recovery in the neighborhood of the entry and the exit to the casing, so natural convection occurs and becomes a cause of another unevenness in the coating.

In U.S. Pat. No. 5,694,701, it is difficult to adopt such a configuration as to place the apparatus for condensation and recovery of a solvent as close as to the coating apparatus, and the method suggested therein is insufficient for a preventive measure against uneven coating.

### SUMMARY OF THE INVENTION

As mentioned above, the drying methods hitherto suggested for coating films, the desired coating compositions and the existing drying units were not enough to fully prevent coatings from developing unevenness at the time of drying.

On the other hand, the Inventor has found that a coating film develops spotted unevenness when a long-length and broad substrate coated with a solvent-containing coating solution, which is to be supported on transport rollers, comes into contact with transport rollers on the non-coated side in a state that the solvent content therein is within a particular range in the process of drying by evaporation of the solvent.

An object of the invention is to provide a method of drying a long-length and broad coating film formed on a continuously traveling substrate by application of a coating solution on condition that the coating film is prevented from developing unevenness in the process of drying by evaporation of solvent and dried efficiently without modifying physical properties of the coating solution and making considerable alterations to existing drying units.

As a result of my intensive study to resolve the foregoing problems, it has been found that the aforesaid object can be attained by adjusting a drying speed to a particular range when the solvent content in a coating film formed on a substrate is within a specified range, and what is more, by transporting the substrate without bringing into contact with transport rollers as long as the solvent content is within the specified range, thereby achieving the invention.

More specifically, the following are embodiments of the invention.

(1) A method of drying a coating film comprising: applying a coating solution containing a solvent to a continuously-transporting substrate so as to form a solvent-containing coating film; and drying the solvent-containing coating film, wherein, when the coating film includes an area having a solvent content in a range of 20% to 45% by mass, the area of the coating film is dried at a rate of 0.2 g/m²·s or above, and a portion of the substrate, on which the area of the coating film is formed, is transported in a non-contact state.

(2) A method of drying as described in (1), wherein the drying rate is from 0.25 g/m²·s to 3.00 g/m²·s.

(3) A method of drying as described in (1) or (2), wherein the area of the coating film is dried at a temperature between 25° C. and 120° C.

(4) A method of drying as described in any of (1) to (3), wherein the area of the coating film is dried at an air velocity of 0.1 m/sec to 1.5 m/sec.

(5) A method of drying as described in any of (1) to (4), wherein a transport distance of the area of the substrate in the non-contact state is 3 m or below.

(6) A method of drying as described in any of (1) to (5), wherein the solvent is an organic solvent selected from ketones or aromatic hydrocarbons.

(7) A method of drying as described in any of (1) to (6), wherein the coating solution is a coating solution for forming an optically functional layer.

(8) A method of drying as described in (7), wherein the coating solution for forming an optically functional layer is a coating solution for forming an anti-glare hard coating layer.

(9) A method of drying as described in (7), wherein the coating solution for forming an optically functional layer is a coating solution for forming a light-diffusing hard coating layer.

(10) A method of drying as described in (7), wherein the coating solution for forming an optically functional layer is a coating solution for forming a layer with a low refractive index.

(11) An optical film having a layer formed by use of a method of drying as described in any of (1) to (10).

(12) An antireflective film prepared by imparting an antireflective property to an optical film as described in (11).

### BRIEF DESCRIPTION OF DRAWING

FIG. 1 is a schematic diagram showing schematically the outline of film manufacturing apparatus equipped with a drying unit suitable for performing the present drying method.

### DETAILED DESCRIPTION OF THE INVENTION

The invention is described below in detail.

The present drying method is a coating film drying method wherein a coating solution containing a solvent is applied to a continuously-transporting substrate to form a coating film and the coating film in a state of containing the solvent is dried, and is characterized in that the drying rate is adjusted to 0.2 g/m²·s or above throughout the period during which the solvent content in the coating film is from 20% to 45% by mass, and what is more, the substrate is transported in a non-contact state as long as the solvent content is in the range specified above.

The term “coating solution” as used herein means liquid matter before application to a substrate, and the term “coating film” as used herein means a coating which is formed by applying a coating solution to a substrate and is in a state of receiving no drying operation yet or in the process of receiving a drying operation. The desired film which is obtained after completion of a drying operation-is described as “layer”.

In the following, the method itself is described first, and then a substrate and a coating solution used, the layer obtained by the present drying method and materials having such a layer are explained.

The invention relates to a drying method adopted at the occasion of applying a coating solution containing a solvent to a substrate transported continuously and drying the coating film formed on the substrate.

In the present drying method, when the coating film has its solvent content in a range of 20% to 45% by mass in the process of drying the coating film through evaporation of a solvent contained therein as the substrate coated with a solvent-containing coating solution is transported continuously in a condition of being supported on rollers on the non-coated side, the drying rate is adjusted to 0.2 g/m²·s or above and the coating film is dried as the substrate on which the coating film is formed is transported in a non-contact state.

When transport rollers come into contact with the substrate under a condition that the solvent content is in the range specified above, unevenness develops even if the contact surface is on the non-coated side. A reason for developing unevenness can be thought to consist in that, when the submicroscopic asperities on the transport roller surface come into contact with the substrate, there appear surface temperature distribution and surface tension distribution in submicroscopic areas of the coating film on the substrate. Even when the asperities on the transport roller surface are too minute for visual observations, unevenness develops.

Therefore, prevention of unevenness requires for the substrate to be transported in a non-contact state without using any transport roller as long as the solvent content is in the range specified above. If an existing drying unit adopted has a transport roller in the section where the solvent content is in the specified range, the transport roller placed in that section may be taken off in the sense that there is no need to make any major alteration to the existing drying unit.

The term “solvent content in a coating solution” as used in this specification is an antonym of the term “solids content in a coating solution”. For instance, the solids content is 80% by mass when the solvent content is 20% by mass, and the solids content is 55% by mass when the solvent content is 45% by mass. The solvent content at an arbitrary point in the process of drying can be calculated from the amount of coating solution applied (g/m²), the concentration of solids in a coating solution before coating and the mass decrement (g/m²) at the arbitrary point. However, it is difficult to directly measure a mass decrement of the coating solution provided on a substrate in process of being transported. Therefore, a drying time that elapses before the substrate reaches the arbitrary point is calculated on the basis of the distance from a coating unit to the arbitrary drying point and the transporting speed. The mass decrement occurring after a lapse of the drying time calculated in advance is determined from off-line coating performed separately, thereby making an estimate of the solvent content.

As long as the solvent content is higher than 45% by mass, no unevenness develops even when transport rollers, etc are in contact with the non-coated side of the substrate. As a reason for this phenomenon, it is thought that, when the coating solution provided on a substrate still contains plenty of solvent, the consistency thereof is so low that leveling effect is produced to avoid unevenness. In the section where the solvent content is higher than 45% by mass, placement of transport rollers is rather preferable in order to ensure consistent transport.

When the solvent content is lower than 20% by mass, no unevenness develops even when the transport rollers, etc are in contact with the non-coated side of the substrate, also. As a reason for this phenomenon, it is thought that, when the solvent content is low, the viscosity of the coating solution is so high that the liquid on the surface of the coating film does not flow to avoid unevenness. Therefore, in the section where the solvent content is lower than 20% by mass, placement of transport rollers is rather preferable in order to ensure consistent transport.

Additionally, the air-floated drying method in which a substrate is dried in a state of being floated up by blowing air on both the coated and non-coated sides, or without coming into contact with rollers, is undesirable because wind unevenness develops by blowing air on the surface of the coating film.

In the present drying method, the drying rate is adjusted to 0.2 g/m² sec or above when the solvent content in the coating film is from 20% to 45% by mass. And it is preferable to adjust the drying rate to 0.25 g/m²·s or above, and it is far preferable to adjust the drying rate to the range of 0.25 g/m²·s to 3.00 g/m²·s.

The drying rate herein can be determined on the basis of results of solvent content measurements in the off-line coating. More specifically, the measurement results are plotted, with solvent content as ordinate and drying time t (sec.) as abscissa, and the time at which the solvent content becomes 45% by mass, t_{45%}, and the time at which the solvent content becomes 20% by mass, t_{20%}, are read off. The drying rate throughout the period during which the solvent content in the coating film is reduced from 45% by mass to 20% by mass is determined using the time required for concentration from the solvent content of 45% by mass to that of 20% by mass and the amount of solvent evaporated (g/m²) during the concentration as well as the amount of coating solution applied (g/m²) and the solids concentration in the coating solution before application. In order to increase the accuracy of reading, solvent content measurements are made at intervals of 1 second during the t=1-to-t=30 period of drying time.

When the drying rate is below 0.2 g/m², the time lapsed between the solvent content of 45% by mass and the solvent content of 20% by mass becomes long, and the distance to be transported in a non-contact state becomes long. When the non-contact transport distance is long, tension puckers develop in the transport direction. It is thought that such puckers result from a long-range tension imposed on the substrate in the transport direction without width-direction support on transport rollers. Although reduction in transporting speed can also be thought to diminish the distance to transport the substrate in a non-contact state, it is undesirable in point of manufacturing efficiency.

The distance traveled by the substrate in a non-contact state under the condition that the solvent content ranges from 20% to 45% by mass is preferably 3 m or below, far preferably 2 m or below, particularly preferably 1 m or below. The distance of 3 m or below is adequate for avoiding the tension pucker trouble.

The solvent contained in a coating solution used in the invention and targeted for drying means an organic compound having the property of dissolving substances. Examples of such an organic compound include aromatic hydrocarbons such as toluene, xylene and styrene, ketones such as acetone, methyl ethyl ketone, methyl isobutyl ketone and cyclohexanone, alcohol compounds such as methanol, isopropyl alcohol and isobutyl alcohol, chlorinated aromatic hydrocarbons such as chlorobenzene and ortho-dichlorobenzene, chlorinated aliphatic hydrocarbons such as methane derivatives including monochloromethane and ethane derivatives including monochloroethane, esters such as methyl acetate and ethyl acetate, ethers such as ethyl ether and 1,4-dioxane, glycol ethers such as ethylene glycol monomethyl ether, alicyclic hydrocarbons such as cyclohexane, and aliphatic hydrocarbons such as normal hexane. Of these compounds, organic solvents of aromatic hydrocarbon series and those of ketone series are preferred over the others.

These organic solvents have no particular restrictions so far as binder resins can be dissolved therein, but the use of methyl ethyl ketone, methyl isobutyl ketone, cyclohexanone or toluene is advantageous from viewpoints of solubility, versatility and cost. In further allowing the drying rate to be controlled, it is beneficial to use a mixture of two or more solvents having different boiling points.

The solvent content in a coating solution is preferably from 40.0% to 99.5% by mass, far preferably from 45.0% to 95.0% by mass.

Additionally, the drying rate and the transporting method applied when the solvent content in the coating film falls outside the range specified in the invention have no particular restrictions, but it is possible to adopt various conditions as long as they cause no deviation from the aims of the invention.

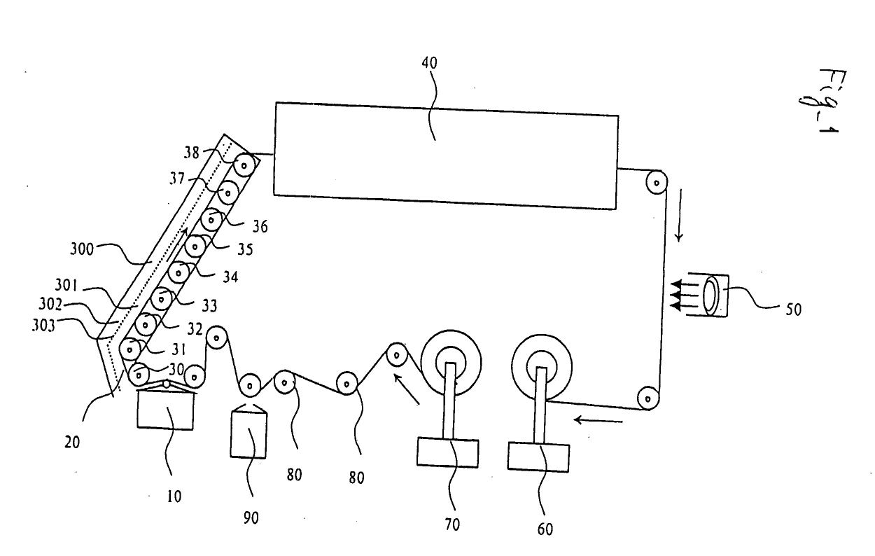

The general outlines of a drying unit according to the invention are illustrated by reference to FIG. 1.

FIG. 1 is a schematic diagram showing schematically an outline of film manufacturing apparatus equipped with a drying unit suitable for performing a drying method according to the invention.

In FIG. 1 is shown antireflective film making apparatus configured so as to include a drying unit relating to the present drying method. According to the making apparatus shown in FIG. 1, a substrate 20 is sent forth by a delivery device 70, and the substrate 20 sent forth is transported to a dust remover 90, and further to a coating unit 10. The dust remover 90 removes dust adhering to the surface of the substrate 20 supported on transport-rollers 80, and a desired coating solution is applied to the dust-removed substrate by means of the coating unit 10, thereby forming a coating film. And the coating film formed is dried in a drying unit 300 structured so as to perform non-contact drying at the specified rate under conditions of the specified range of solvent contents that characterize the invention. Thereafter, the substrate 20 undergoes finishing dry treatment by passage through a heater 40, and further the coating film formed on the substrate 20 is cured by irradiation with an ultraviolet lamp 50. Thus, the desired layer is obtained. When the coating solution contains a thermosetting binder, the coating film is cured by passage through the heater 40, and the desired layer is obtained. The substrate 20 coated with the layer is taken up by means of a winder 60. In the case of laminating a plurality of layers on the substrate, the substrate coated with the first layer is mounted again on the delivery device 70, and a coating solution for forming a second layer is applied, dried, cured and then taken up. Further lamination can be performed by repeating those procedures. The number of laminated layers has no particular limitation, but multiple layers may be formed.

The drying unit 300 relating to the characteristic part of the present drying method is described below. After applying a coating solution by means of a coating unit 10, an initial drying operation is carried out using a drying unit 300 disposed directly behind the coating unit 10. In the drying unit 300, transport rollers 30, 31, 32, 33, 34, 35, 36, 37 and 38 are installed, and each individual roller is detachable, and what is more, it is preferable that each roller is detached with ease. Though all transport rollers are drawn in FIG. 1 for convenience's sake, transporting rollers fitting into the region where the solvent content in the coating solution is from 20% to 45% by mass are detached in the practical drying process, and the coating film is transported, as mentioned above, in a non-contact state in that region. In addition, it is preferable that the roller surface temperatures of the transport rollers 30, 31, 32, 33, 34, 35, 36, 37 and 38 can be controlled. Since it is important in preventing unevenness that no surface temperature distribution is caused to the coating film, the surface temperatures of the transport rollers 30, 31, 32, 33, 34, 35, 36, 37 and 38 are preferably adjusted to the nearest possible temperature of the atmosphere in the drying unit 300.

The drying unit 300 is provided with a passage room 301 through which the substrate is made to pass and an exhaust room 302 for emission of the solvent vaporized. An airflow control plate 303 is disposed so as to compartmentalize the passage room 301 and the exhaust room 302. The exhaust room 302 is fitted with an exhaust pipe and an air intake pipe, and air (or another gas instead) is fed into the exhaust room 302 via the air intake pipe. The exhaust pipe and the air intake pipe are fitted on opposite sides, respectively, in the width direction of the substrate 20. The airflow control plate 303 has no particular restrictions as to the aperture and the material, but it is preferable to use metal gauze or punched metal having an aperture percentage of 50% or below, preferably from 20% to 40%. More specifically, it is possible to use 300-mesh metal gauze having an aperture percentage of 30%. Additionally, the airflow control plate 303 is installed so as to leave a clearance of 10 mm from the surface of the coating film formed on the substrate 20.

The air velocity in the passage room 301 is preferably from 0.1 m/sec to 1.5 m/sec, far preferably from 0.1 m/sec to 1.0 m/sec, especially preferably from 0.2 m/sec to 1.0 m/sec. When the air velocity is lower than 0.1 m/sec, the drying rate is substantially lowered, and satisfactory drying cannot be performed in the drying unit 300 wherein the airflow is controlled. So the coating film is made to pass through the heater 40 of a draft drying type as it contains a plenty of solvent; as a result, it suffers badly from unevenness. In order to address this problem, it is required to increase the length of the drying unit 300. However, an increase in length of the drying unit exacerbates the coating efficiency. When the air velocity is higher than 1.5 m/sec, the coating surface is disturbed by the air flow, and the thickness of the coating film becomes non-uniform to develop unevenness.

The temperature inside the drying unit 300 is preferably from 20° C. to 120° C., far preferably from 25° C. to 120° C., especially preferably from 25° C. to 100° C. When the temperature inside the drying unit 300 is lower than 20° C., sufficient drying cannot be performed inside the drying unit 300 wherein the airflow is controlled, though it depends on the kind of-the solvent contained in the coating solution. So the coating film is made to pass through the heater 40 of a draft drying type as it contains a plenty of solvent; as a result, it suffers badly from unevenness. On the other hand, the temperatures higher than 120° C. inside the drying unit 300 are undesirable because there occurs a trouble that additives contained in the substrate 20 are vaporized and dispersed.

As described above, the control of air velocity or temperature inside the drying unit is an example of the method for controlling the drying rate, but the drying rate control can be achieved by various methods without being limited to such an example.

Examples of a process of forming a coating by application of a coating solution include bar coating, curtain coating, extrusion coating, roll coating, dip coating, spin coating, gravure coating, micro-gravure coating, spray coating and slide coating. Of these processes, micro-gravure coating, gravure coating, bar coating and extrusion coating, in particular, are preferred.

Substances to which the present drying method is applicable are described below.

As a substrate to which a coating solution is applied, plastic film is preferably used. Examples of a polymer capable of forming plastic film include cellulose esters (such as triacetyl cellulose and diacetyl cellulose, typically TAC-TD80U and TD80UF, produced by Fuji Photo Film Co., Ltd.), polyamide, polycarbonate, polyesters (such as polyethylene terephthalate and polyethylene naphthalate), polystyrene, polyolefin, norbornene resins (such as ARTON, trade name, produced by JSR Corporation) and amorphous polyolefin (such as ZEONEX, trade name, produced by ZEON Corporation). Of these polymers, triacetyl cellulose, polyethylene terephthalate and polyethylene naphthalate are preferred over the others. And triacetyl cellulose in particular is used to advantage. In addition, Kokai Giho (Journal of Technical Disclosure) issued by the JIII (Japan Institute of Invention and Innovation), Kogi No. 2001-1745, issued on Mar. 15, 2001 (hereinafter abbreviated as Kokaigiho 2001-1745) discloses cellulose acylate films substantially free of halogenated hydrocarbons such as dichloromethane and manufacturing methods thereof, and the use of cellulose acylates disclosed therein is also advantageous in the invention.

As a coating solution, it is preferable to use a coating solution for forming an optically functional layer. The coating solution for forming an optically functional layer is preferably a coating solution for forming an antiglare hard coating layer, a coating solution for forming a light-diffusing hard coating layer, or a coating solution for forming a low refractive index layer. More specifically, an antireflective film used in a display unit in particular is placed at the front of the display, it is required to have especially high quality with respect to the surface conditions including evenness. The antireflective film is prepared by forming on a substrate a low refractive index layer of an appropriate thickness as the uppermost layer and, if necessary, further forming an anti-glare hard coating layer and a light-diffusing hard coating layer between the substrate and the low refractive index layer. When a coating solution for forming a low refractive index layer, a coating solution for forming an anti-glare hard coating layer and a coating solution for forming a light-diffusing hard coating layer are applied to a substrate and dried in accordance with the present drying method, an unevenness-free antireflective film can be formed.

The coating solution for forming a low refractive index layer, the coating solution for forming an anti-glare hard coating layer and the coating solution for forming a light-diffusing hard coating layer are described below.

(Coating Solution for Forming Low Refractive Index Layer)

The coating solution for forming a low refractive index layer is a coating solution for forming the low refractive index layer described below. Since the description of solvents is given above, solvent description is omitted from the following descriptions.

The low refractive index layer is preferably formed as a cured film of a copolymer having as essentialc onstituents repeating units derived from fluorine-containing vinyl monomers and repeating units containing (meth)acryloyl groups in their respective side chains. The component originating from the copolymer makes up preferably at least 60% by mass, far preferably at least 70% by mass, particularly preferably at least 80% by mass, of the solids in the film. From the viewpoint of achieving both low refractive index and high film hardness at the same time, it is also beneficial to use a curing agent, such as a multifunctional (meth)acrylate, so long as the curing agent is added in amounts. causing no impairment in compatibility with the copolymer.

The refractive index of the low refractive index layer is preferably from 1.20 to 1.46, far preferably from 1.25 to 1.46, particularly preferably from 1.30 to 1.46.

The thickness of the low refractive index layer is preferably from 50 to 200 nm, far preferably from 70 to 100 nm. The haze of the low refractive index layer is preferably 3% or below, far preferably 2% or below, especially preferably 1% or below. As to specific hardness evaluated in the pencil hardness test using a load of 500 g, it is appropriate that the low refractive index layer have a hardness of H or above, preferably 2H or above, especially preferably 3H or above.

For improving soil-resistant properties of optical films, it is appropriate that the layer surface has a contact angle of 90° or above, far preferably 95° or above, particularly preferably 100° or above, with respect to water.

Copolymers used preferably in the low refractive index layer are described below.

Examples of a fluorine-containing vinyl monomer include fluorinated olefins (such as fluoroethylene, vinylidene fluorine, tetrafluoroethylene and hexafluoropropylene), compounds derived from partially or fully fluorinated alkyl esters of (meth)acrylic acid (such as Viscote 6FM, trade name, produced by Osaka Organic Chemical Industry Ltd., and R-2020, trade name, produced by Daikin Industries Ltd.), and partially or fully fluorinated vinyl ethers. Of these monomers, perfluoroolefins are preferred over the others, and hexafluoropropylene in particular is used to advantage from the viewpoints of refractive index, solubility, transparency and availability. While an increased fraction of fluorine-containing vinyl monomer can reduce the refractive index of the resulting copolymer, it causes reduction in strength of film formed, too. In the invention, it is therefore appropriate to introduce fluorine-containing monomers so that the fluorine content in the resulting copolymer falls within the range of 20% to 60% by mass, preferably 25% to 55% by mass, particularly preferably 30% to 50% by mass.

It is preferable that the copolymer contains repeating units having (meth)acryloyl groups in their respective side chains as its essential constituents. While an increased fraction of these (meth)acryloyl group-containing repeating units enhances the strength of the film formed, it also heightens the refractive index. Depending on the types of repeating units derived from fluorine-containing vinyl monomers, it is generally appropriate that the fraction of (meth)acryloyl group-containing repeating units is from 5% to 90% by mass, preferably from 30% to 70% by mass, particularly preferably from 40% to 60% by mass.

In addition to the repeating units derived from fluorine-containing vinyl monomers and the repeating units having (meth)acryloyl groups in their respective side chains, other vinyl monomers can also be copolymerized as appropriate from the viewpoints of adhesion to substrates, Tg of the copolymer obtained (which can contribute to hardness of the film formed), solubility in solvents, transparency, slipping property, and dust- and soil-resistant properties. Two or more of these vinyl monomers may be used in combination according to the desired purpose, and it is appropriate to introduce them into the copolymer in a total fraction of 0 to 65% by mole, preferably 0 to 40% by mole, particularly preferably 0 to 30% by mole.

There is no particular restriction as to vinyl monomer units usable in combination, but examples thereof may include olefins (such as ethylene, propylene, isoprene, vinyl chloride and vinylidene chloride), acrylic acidesters (such as methyl acrylate, ethyl acrylate, 2-ethylhexyl acrylateand2-hydroxyethyl acrylate), methacrylic acid esters (such as methyl methacrylate, ethyl methacrylate, butyl methacrylate and 2-hydroxyethyl methacrylate), styrene derivatives (such as styrene, p-hydroxymethylstyrene and p-methoxystyrene), vinyl ethers (such as methyl vinyl ether, ethyl vinyl ether, cyclohexyl vinyl ether, hydroxyethyl vinyl ether and hydroxybutyl vinyl ether), vinyl esters (such as vinyl acetate, vinyl propionate and vinyl succinate), unsaturated carboxylic acids (such as acrylic acid, methacrylic acid, crotonic acid, maleic acid and itaconic acid), acrylamides (such as N,N-dimethylacrylamide, N-tert-butylacrylamide and N-cyclohexylacrylamide), methacrylamides (such as N,N-dimethylmethacrylamide), and acrylonitrile.

The proportion of a copolymer mixed in the coating solution is preferably from 1% to 20% by mass, far preferably from 3% to 10% by mass, of the overall coating solution.

Inorganic fine particles which can be-preferably used in the low refractive index layer of an antireflective film formed in accordance with the invention are described below.

The coverage of inorganic fine particles is preferably from 1 mg/m² to 100 mg/m², far preferably from 5 mg/m² to 80 mg/m², further preferably from 10 mg/m² to 60 mg/m². When the inorganic fine particles are used in too small an amount, reduction in effect of improving scratch resistance occurs in some cases; while, when the fine particles are used in too large an amount, microscopic asperities are formed on the surface of the low refractive index layer, and there sometimes occur deterioration in the outward appearance, such as deep blacks, and lowering of integrated reflectance. Since inorganic fine particles are incorporated in the low refractive index layer, it is preferable that the particles have a low refractive index.

Specifically, fine particles of inorganic oxides or hollow inorganic oxides which are improved in dispersive property by undergoing silylation treatment and have a low refractive index are used to advantage. An example of such inorganic fine particles is fine silica particles or hollow fine silica particles. The average particle diameter of fine silica particles is preferably from30% to 150%, far preferably from 35% to 80%, further preferably from 40% to 60%, of thickness of the low refractive index layer. Specifically, when the thickness of the low refractive index layer is, e.g., 100 nm, the average particle diameter of fine silica particles is preferably from 30 nm to 150nm, far preferably from 35 nm to 80 nm, further preferably from 40 nm to 60 nm.

When the diameter of fine silica particles used is too small, the particles sometimes produce little effect on scratch-resistance improvement; while, when the diameter of fine silica particles used is too large, fine asperities are formed on the surface of the low refractive index layer, so there sometimes occur deterioration in the outward appearance, such as deep blacks, and lowering of integrated reflectance. The fine silica particles may be in a crystalline or amorphous state, and they may be monodisperse particles or aggregate particles so long as they meet the particle diameter requirements. While their best shape is a spherical shape, they may be indefinite in shape.

For reduction in refractive index of the low refractive index layer, it is favorable to use hollow fine particles of silica. The refractive index of hollow fine particles of silica is from 1.17 to 1.40, preferably from 1.17 to 1.35, far preferably from 1.17 to 1.30. The refractive index specified herein represents the refractive index the particles have in their entirety, and it does not represent the refractive index of only the outer shells forming hollow silica particles.

When the radius of a cavity in each particle is taken as “a” and the radius of an outer shell of each particle as “b”, the porosity x is calculated from the following mathematical expression (I).
x=(4πa³/3)/(4πb³/3)×100 (Mathematical Expression I)

The porosity x is preferably from 10% to 60%, far preferably from 20% to 60%, particularly preferably 30% to 60%. When it is intended to allow hollow silica particles to have a lower refractive index and a greater porosity, the outer shell thickness is reduced and the particle strength is lowered. Therefore, particles having a refractive index lower than 1.17 are not viable in point of scratch resistance.

Refractive index measurements of those hollow particles of silica are made with an Abbe refractometer (made by ATAGO Co., Ltd.).

Incorporation of those hollow particles into a low refractive index layer can lower the layer's refractive index. When the hollow particles are used, the refractive index of the resulting layer is preferably from 1.20 to 1.46, far preferably from 1.25 to 1.41, particularly preferably from 1.30 to 1.39.

In addition, it is preferable that at least one type of fine silica particles having an average particle diameter smaller than 25% of the thickness of the low refractive index layer (referred to as “fine silica particles of small-size type”) is used in combination with the fine silica particles having the average particle diameter specified hereinbefore (referred to as “fine silica particles of large-size type”.

Since fine silica particles of small-size type can fill in gaps between fine silica particles of large-size type, they can function as a holding agent for the fine silica particles of large-size type.

When the low refractive index layer has a thickness of, e.g., 100 nm, the average particle diameter of the fine silica particles of small-size type is preferably from 1 nm to 20 nm, far preferably from 5 nm to 15 nm, particularly from 10 nm to 15 nm. The use of such fine silica particles is favorable from the viewpoints of the cost of raw materials and their holding effect.

The proportion of the inorganic fine particles mixed in the coating solution is preferably from 0.1% to 10.0% by mass, far preferably from 1.0% to 5.0% by mass, of the overall coating solution.

From the viewpoint of enhancing soil resistance, it is preferable in the invention to lower surface free energy of the antireflective film surface. Specifically, it is preferable to use a fluorine-containing compound or a silicone compound having a polysiloxane structure in the low refractive index layer. Suitable examples of an additive having a polysiloxane structure include polysiloxanes having reactive groups (such as KF-110T, X-22-169AS, KF-102, X-22-37011E, X-22-164B, X-22-5002, X-22-173B, X22-174D, X-22-167B and X-22-161AS (which are trade names and products of Shin-Etsu Chemical Co., Ltd.), AK-5, AK-30 and AK-32 (which are trade names and products of Toagosei Co., Ltd.), and Silaplaine FM0725 and Silaplaine FM0721 (which are trade names and products of Chisso Corporation, but they are not limited to these products. In addition, the silicone compounds disclosed in Tables 2 and 3 of JP-A-2003-112383 can also be used to advantage. It is preferable that these polysiloxanes are added in an amount of 0.1 to 10% by mass, especially 1 to 5% by mass, of the total content-of solids in the low refractive index layer.

(Coating Solution for Formation of Anti-glare Hard Coating Layer and Coating Solution for Formation of Light-diffusing Hard Coating Layer)

The coating solution for formation of an anti-glare hard coating layer and the coating solution for formation of a light-diffusing hard coating layer are coating solutions for forming hard coating layers having an anti-glare property and a light-diffusing property, respectively. These two solutions differ in containing either a compound having an anti-glare property or a compound having a light-diffusing property, but they are the same on other points. In the following descriptions, their commonalities are mentioned first, and then compounds having an anti-glare property and compounds having a light-diffusing property are described. As to the solvents, the description thereof is given hereinbefore, so it is omitted from the following descriptions.

The hard coating layer is made up of a binder, matting particles for imparting an anti-glare or light-diffusing function and inorganic fine particles for heightening a refractive index, preventing shrinkage by cross-linking and enhancing the strength. In other words, by using matting particles having either of the two functions, it becomes possible to prepare selectively either a coating solution for formation of an anti-glare hard coating layer or a coating solution for formation of a light-diffusing hard coating layer.

In point of film strength, stability of coating solutions and manufacturability of coating films, it is favorable to use compounds having ethylenic unsaturated groups as binder constituents. The main film-forming binder refers to the binder making up at least 10% by mass of the film-forming components except inorganic fine particles. The main film-forming binder's percentage is preferably from 20% to 100% by mass, far preferably from 30% to 95% by mass.

The main film-forming binder is preferably a polymer having as its main chain a saturated hydrocarbon chain or a polyether chain, far preferably a polymer having as its main chain a saturated hydrocarbon chain. As a binder polymer having a saturated hydrocarbon chain as its main chain and a cross-linked structure, a (co) polymer derived from a monomer having at least two ethylenic unsaturated groups is suitable.

For attainment of a high refractive index, it is appropriate to incorporate into the structure of such a monomer an aromatic ring and at least one atom selected from halogen atoms other than a fluorine atom, a sulfur atom, a phosphorus atom or a nitrogen atom.

Examples of a monomer having at least two ethylenic unsaturated groups include polyhydric alcohol esters of (meth)acrylic acid [such as ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythrithol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate], vinylbenzene and derivatives thereof [such as 1,4-divinylbenzene, 2-acryloylethyl 4-vinylbenzoate and 1,4-divinylcyclohexanone], vinyl sulfones (such as divinyl sulfone), acrylamides (such as methylenebisacrylamide) and methacrylamides. These monomers may be used as combinations of two or more thereof. Additionally, the expression “(meth)acrylate” as used herein stands for acrylate or methacrylate.

Examples of a monomer having a high reflective index include bis(4-methacryloylthiophenyl) sulfide, vinylnaphthalene, vinyl phenyl sulfide and 4-methacryloxyphenyl-4′-methoxyphenylthioether. These monomers also may be used as combinations of two or more thereof.

These monomers having ethylenic unsaturated groups can be polymerized by irradiation with ionizing radiation or heating in the presence of a photo-radical initiator or a thermo-radical initiator, respectively.

Examples of a photo-radical polymerization initiator include acetophenones, benzoins, benzophenones, phosphineoxides, ketals, anthraquinones, thioxanthones, azo compounds, peroxides, 2,3-dialkyldione compounds, disulfide compounds, fluoroamine compounds and aromatic sufoniums. Examples of acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone and 2-benzyl-2-dimethylamino-l-(4-morpholinophenyl)-butanone. Examples of benzoins include benzoin benzenesulfonate, benzoin toluenesulfonate, benzoin methyl ether, benzoin ethyl ether and benzoin isopropyl ether. Examples of benzophenones include benzophenone, 2,4-dichlorobenzophenone, 4,4-dichlorobenzophenone and p-chlorobenzophenone. Examples of phosphine oxides include 2,4,6-trimethylbenzoyldiphenylphosphine oxide.

Various examples of photo-radical polymerization initiators are also described in Saishin UV Koka Gijutu (p. 19, publisher: Kazuhiro Takausu, publishing office; Technical Information Institute Co., Ltd., date of issue: 1991), and they are useful in the invention.

Suitable examples of a commercially available photo-radical polymerization initiator of photo-cleavage type include Irgacure 651, 184 and 907 produced by Nihon Ciba-Geigy K.K.

It is appropriate to use a photopolymerization initiator in an amount range of 0.1 to 15 parts by mass, preferably 1 to 10 parts by mass, per 100 parts by mass of multifunctional monomer.

In addition to the photo-polymerization initiator, a photo-sensitizer may be used. Examples of a photo-sensitizer include n-butylamine, triethylamine, tri-n-butylphosphine, Michler's ketone and thioxanthone.

As the thermo-radical initiator, an organic or inorganic peroxide and organic azo and diazo compounds can be used.

Examples of an organic peroxide include benzoyl peroxide, halogenobenzoyl peroxide, lauroyl peroxide, acetyl peroxide, dibutyl peroxide, cumene hydroperoxide and butyl hydroperoxide, and examples of an inorganic peroxide include hydrogen peroxide, ammonium persulfate and potassium persulfate. Examples of an azo compound include 2-azo-bis-isobuyronitrile, 2-azo-bis-propionitrile and 2-azo-bis-cyclohexanedinitrile, and examples of a diazo compound include diazoaminobenzene and p-nitrobenzenediazonium.

Polymers having polyether chains in their respective main chains can also be used in the invention. As such polymers, polymers obtained by ring opening polymerization of multifunctional epoxy compounds are suitable. The ring opening polymerization of multifunctional epoxy compounds can be performed by irradiation with ionizing radiation or heating in the presence of a photo-acid generator or a thermo-acid generator, respectively.

A cross-linked structure may be introduced into a binder polymer by using a monomer having a cross-linkable functional group in place of or in addition to a monomer having two or more ethylenic unsaturated groups and introducing cross-linkable functional groups into the polymer, and further by allowing these cross-linkable functional groups to undergo reaction.

Examples of such a cross-linkable functional group include an isocyanate group, an epoxy group, an aziridine group, an oxazoline group, an aldehyde group, a carbonyl group, a hydrazine group, a carboxyl group, a methylol group and an active methylene group. And vinyl sulfonic acid, acid anhydrides, cyanoacrylate derivatives, melamine, etherified methylol, ester and urethane, and further metal alkoxides, such as tetramethoxysilane, can be utilized as monomers for introduction of cross-linked structures. Further, functional groups showing cross-linkability as a result of decomposition reaction, such as blocked isocyanate groups, may be used. In other words, cross-linkable functional groups used in the invention needn't cause reaction immediately but may be those showing reactivity as a result of decomposition.

Binder polymers having those cross-linkable functional groups can form cross-linked structures by heating after they are coated.

The mixing proportion of the binder is adjusted to make up preferably 20% to 70% by mass, far preferably 35% to 55% by mass, of the total solids in a coating solution for formation of a hard coating layer.

For the purpose of imparting anti-glare or/and light-diffusing properties, various kinds of matting particles and fine particles can be incorporated in a hard coating layer. The matting particles are particles used for the purpose of imparting an anti-glare property or both anti-glare and light-diffusing properties, and those having an average particle diameter ranging from 0.1 to 10 μm, preferably from 0.5 to 5 μm, can be used. Particles of an inorganic compound or a resin, which have their particle diameters in the foregoing range, can be used as matting particles. Although it depends on the extent of allowance made for effect of light diffusion by the matting particles, the refractive index difference between matting particle and binder is generally 0.5 or below, preferably 0.2 or below. When the difference is too great, the resulting film suffers from a defect of developing a milky turbidity. As is the case with the refractive index difference, too large an amount of matting particles added to the binder causes a defect that a milky turbidity appears in the resulting film. So the proportion of the matting particles added is preferably from 3% to 30% by mass, particularly preferably from 5% to 20% by mass.

When the matting particles are used for imparting an anti-glare function alone and the light-diffusing effect caused thereby is intended for minimization, it is preferable to minimize the refractive index difference between matting particle and binder. Herein, the refractive index difference is preferably 0.04 or below, particularly preferably 0.02 or below.

When the matting particles are used for the purpose of imparting both anti-glare and light-diffusing properties, the refractive index difference between matting particle and binder is preferably 0.5 or below, far preferably from 0.01 to 0.2, further preferably from 0.02 to 0.10.

Examples of such matting particles include particles of an inorganic compound, such as silica particles or TiO₂ particles; and resin particles, such as acrylic resin particles, cross-linked. acrylic resin particles, polystyrene particles, cross-linked polystyrene particles, melamine resin particles and benzoguanamine resin particles. Of these particles, cross-linked polystyrene particles, cross-linked acrylic resin particles and silica particles are preferred over the others.

As to the shape of the matting particles, a spherical shape and an indefinite shape are both usable.

In the hard coating layer, two or more different types of matting particles may be used in combination. For achieving effective refractive-index control by the combined use of different types of matting particles, the difference between the irrefractive indexes is preferably from 0.02 to 0.10, particularly preferably from 0.03 to 0.07. Further, it is possible to impart an anti-glare property by use of matting particles greater in particle diameter and other optical properties by use of matting particles smaller in particle diameter. For instance, in sticking an antireflective film on a high-definition display of 133 ppi or above, it is required not to cause the defective condition referred to as “glare” from the viewpoint of optical performance. Although the glare stems from a loss in uniformity of brightness through magnification or reduction of picture elements by asperities present on the film surface (which can contribute to prevention of glare under certain circumstances), significant improvement in glare can be made by increasing scatter of light through a combined use of matting particles for imparting an anti-glare property and other matting particles smaller in particle diameter and different in refractive index from the binder used or fine particles as described hereinafter.

As the particle diameter distribution of the matting particles of each type, a monodisperse distribution is most suitable. The closer their particle diameters are to one another, the more suitable the particles are for use. When the particles whose diameters are greater by 20% or more than the average particle diameter are defined as coarse particles, it is appropriate that the proportion of the coarse particles to the all particles used is 1% or below by number, preferably 0.1% or below by number, far preferably 0.01% or below by number. Matting particles having such a narrow particle diameter distribution can generally be obtained by size classification after synthesis reaction, and the distribution can be made more desirable by increasing the number of times the classification is carried out or making the degree of classification stricter.

Those matting particles are mixed in a coating solution for formation of a hard coating layer so that their content in the hard coating layer formed is preferably from 10 to 1000 mg/m², far preferably from 100 to 700 mg/m².

The size distribution of matting particles is measured according to the Coulter Counter method, and the distribution measured is converted to the number distribution of particles.

For further heightening the refractive index of a hard coating layer and reducing curing shrinkage, it is appropriate that inorganic fine particles including the oxide of at least one metal chosen from titanium, zirconium, aluminum, indium, zinc, tin or antimony and having an average particle diameter of 0.2 μm or below, preferably 0.1 μm or below, far preferably 0.06 μm or below, be incorporated into the hard coating layer in addition to the matting particles.

In a hard coating layer using matting particles of a high refractive index, it is also preferable to use an oxide of silicon for the purpose of widening a difference with the matting particles, and thereby to keep the refractive index of the layer at a rather low value. The suitable particle diameters of silicon oxide are the same as those of the foregoing inorganic fine particles.

Examples of inorganic fine particles usable in the hard coating layer include fine particles of TiO₂, ZrO₂, Al₂O₃, In₂O₃, ZnO, SnO₂, Sb₂O₃, ITO and SiO₂. Of these inorganic fine particles, TiO₂ and ZrO₂ are preferred over the others from the viewpoint of heightening the refractive index. It is also preferable that the inorganic fine particles undergo surface treatment with a silylating agent, and it is advantageous to use a surface treatment agent giving a functional group capable of reacting with the binder to the filler surface.

The addition amount of these inorganic fine particles is preferably from 10 to 90%, far preferably from 20 to 80%, particularly preferably from 30 to 75%, of the total mass of the hard coating layer.

Since the particle diameters of such inorganic fillers are sufficiently smaller than the wavelengths of light, no scattering is caused, and the dispersion of those inorganic fillers in the binder polymer can behave like an optically uniform material.

The bulk refractive index of a mixture of binder and inorganic fine particles in a hard coating layer is preferably from 1.48 to 2.00, far preferably from 1.50 to 1.80. For adjusting the refractive index to such a range, it is sufficient to properly choose the kinds of binder and inorganic fine particles and the mixing proportions thereof. How to make a proper choice can be experimentally found in advance.

Although optical films are included in examples of a film manufactured in accordance with the present drying method described above, the invention is not limited to these films but applicable to films for various purposes without departure from the scope of the invention.

Optical films according to the present invention are described below.

The optical films according to the invention are films having layers formed using the present drying method. And an antireflective film formed by acquiring an antireflective property is a suitable example of optical films according to the invention.

The present optical film is prepared by forming on the substrate the low refractive index layer and the anti-glare or light-diffusing hard coating layer.

The thickness of the substrate is preferably from 35 to 200 μm, far preferably from 55 to 100 μm. The thickness of the low refractive index layer is preferably from 0.02 to 0.30 μm, far preferably from 0.07 to 0.15 μm. The thickness of the anti-glare hard coating layer is preferably from 0.5 to 15.0 μm, far preferably from 2.0 to 8.0 μm. The thickness of the light-diffusing hard coating layer is preferably from 0.5 to 15.0 μm, far preferably from 2.0 to 8.0 μm.

It is preferable that the present optical film thus formed has its haze value in the range of 3 to 70%, preferably 4 to 60%, and the average reflectivity thereof in the wavelength range of 450 nm to 650 nm is 3.0% or below, preferably 2.5% or below.

By having its haze value and average reflectivity in the foregoing ranges, the present optical film can acquire satisfactory anti-glare and antireflective properties without suffering from degradation in transmission images.

In the case of using the present optical film in a liquid crystal display unit, one side of the film is provided with a pressure-sensitive adhesive layer and placed at the front of the display. Since triacetyl cellulose is used as a protective film for protecting the polarizing layer of a polarizing plate when the transparent substrate is triacetyl cellulose, it is advantageous in point of cost that the present optical film is used as a protective film as it is.

When the present optical film is placed at the front of the display via a pressure-sensitive adhesive layer provided on one side thereof, or when it is used as the protective film for a polarizing plate as it is, it is favorable for impartment of sufficient adhesion that the uppermost layer made up almost exclusively of a fluorine-containing polymer is formed on the transparent substrate and then saponification treatment is carried out. The saponification treatment can be performed in known manners. For instance, the film to be treated is immersed in an alkali solution for an appropriate time. After immersion in the alkali solution, it is preferable that the film is washed thoroughly with water so as not to leave the alkali component in the film or it is soaked in a dilute acid to neutralize the alkali component.

By the saponification treatment, the surface of the transparent substrate becomes hyldrophilic on the side opposite to the uppermost layer side.

The hydrophilic surface is effective especially in improving adhesion to a polarizing film containing polyvinyl alcohol as a main constituent. In addition, the hydrophilic surface resists adhesion of dust in the air, so the juncture between the polarizing film and the optical film can resist intrusion by dust at the time of lamination of the optical film on the polarizing film. Therefore, the surface rendered hydrophilic is effective for prevention of point defects by dust.

It is appropriate that the saponification treatment be carried out so that the transparent substrate surface on the side opposite to the uppermost layer side has a contact angle of 40° or below, preferably 30° or below, particularly preferably 20° or below, with respect to water.

As a method for alkali saponification treatment, the following procedure (1) or (2) can be chosen. The procedure (1) is superior in that the treatment can be performed in the same process as that for general-purpose triacetyl cellulose film, but the antireflective layer surface also undergoes the saponification treatment. As a result, there may occur a problem that the antireflective layer suffers alkali hydrolysis at the surface and declines in quality, or the alkali solution used for saponification treatment leaves stains if remains on the antireflective layer surface. In such a case, the adoption of procedure (2) is superior although it requires a special process.

(1) After forming an antireflective laver on a transparent substrate, the film obtained is immersed in an alkali solution at least once, thereby saponifying the back of the film.

(2) Before or after forming an antireflective layer on a transparent substrate, the substrate is coated with an alkali solution at only the surface on the side opposite to the optical film formation side, heated, and then washed with water and/or neutralized, thereby saponifying only the back of the film.

The present antireflective film is preferably used as at least one of the two protective films to be placed on both sides of a polarizing film. By allowing the present optical film to serve as protective film also, the manufacturing cost of a polarizing plate can be reduced. In addition, the use of the present optical film as the uppermost layer can prevent reflected-image appearance by reflection of external light and impart excellent scratch-resistant and soil-resistant properties to the polarizing plate.

As the other polarizing film, any of known polarizing films or a polarizing film cut from a long-length polarizing film having an absorption axis neither parallel nor perpendicular to the direction of the length may be utilized. The long-length polarizing film whose absorption axis is neither parallel nor perpendicular to the direction of the length can be made in the following manner.

Specifically, such a polarizing film can be manufactured by stretching a polymer film fed continuously under a tension while holding both edges thereof with holding tools. Herein, the polymer film is stretched to 1.1 to 20.0 times its original length in the direction of the width. Further, the length-direction traveling speed difference between the film-edge holding tools is controlled to 3% or below, and the traveling direction of the film is bend as the film edges are held with the holding tools so that the film traveling direction at the exit from the film edge holding process tilts 20 to 70 degrees toward the substantial stretch direction of the film. The 45° tilt of the film traveling direction is especially favorable from the viewpoint of manufacturability.

Detailed description of the polymer film stretching method can be found in JP-A-2002-86554, paragraphs [0020] to [0030].

When the present optical film is used as a surface protective film on one side of a polarizing film, the resulting polarizing plate can be favorably used in a transmission, reflection or semi-transmission liquid crystal display of a twisted nematic (TN) mode, a super twisted nematic (STN) mode, a vertical alignment (VA) mode, an in-plane switching (IPS) mode or an optically compensatory bend cell (OCB) mode.

Examples of a VA-mode liquid crystal cell include (1) a strictly VA-mode liquid crystal cell in which rod-shaped liquid crystalline molecules are aligned in a substantially vertical direction when no voltage is applied thereto, but they are forced to align in a substantially horizontal direction by application of a voltage thereto (as disclosed in JP-A-2-176625), (2) a multidomain VA-mode (MVA-mode) liquid crystal cell (as described in SID 97 Digest of Tech. Papers (preprints) 28, p. 845(1997)), (3) an n-ADM-mode liquid crystal cell in which rod-shaped liquid crystalline molecules are aligned in a substantially vertical direction when no voltage is applied thereto, but they are brought into a twisted multidomain alignment by application of a voltage thereto (as described in the digest of reports presented at Nippon Ekisho Toronkai (Symposium on Liquid Crystal), pp. 58-59 (1998)), and (4) a SURVAIVAL-mode liquid crystal cell (announced at LCD International 98).

In a VA-mode liquid crystal cell, a polarizing plate made by combining a biaxially stretched triacetyl cellulose film with the present optical film is used to advantage. In preparing the biaxially stretched triacetyl cellulose, it is preferable to adopt the methods as described in JP-A-2001-249223 and JP-A-2003-170492.

OCB-mode liquid crystal cells are liquid crystal displays using liquid crystal cells of a bend alignment mode in which rod-shape liquid crystalline molecules in the upper part of a liquid crystal cell and those in the lower part are forced to align (symmetrically) in substantially opposite directions, and they are disclosed in U.S. Pat. Nos. 4,583,825 and 5,410,422. Since the rod-like liquid crystal molecules are symmetrically aligned in an upper part and a lower part of the liquid crystal cell, the liquid crystal cell of a bend orientation mode has an optically self-compensation function. Therefore, this liquid crystal mode is referred to as an OCB (optically compensatory bend) liquid crystal mode. The liquid crystal display of the bend orientation mode has an advantage of high response speed.

ECB-mode liquid crystal cells, in which rod-shape liquid crystalline molecules are aligned in a substantially horizontal direction when no voltage is applied thereto, are prevailingly utilized as color TFT liquid crystal displays, and described in an abundant technical literature. For example, descriptions thereof can be found in EL, PDP and LCD Displays, published by Toray Research Center (2001).

In TN-mode and IPS-mode liquid crystal displays in particular, both antireflective effect and viewing angle expanding effect can be achieved with a thickness of only one polarizing plate by using an optically compensatory film having a viewing angle expanding effect as one of both the front and back protective films of a polarizing film, as described in JP-A-2001-100043, on the side opposite to the present optical film formation side. Therefore, such a case is especially favorable.

### EXAMPLES

The invention will now be illustrated in more detail by reference to the following examples and comparative examples, but these examples should not be construed as limiting the scope of the invention in any way.

Examples and comparative examples designated as Experiments A to J were each conducted with a model apparatus shown in FIG. 1. However, apparatus enabling achievement of effects the invention desires to have is not limited to the apparatus illustrated below, but the effects can be achieved by some other apparatus.

More specifically, the following operations are performed in each of Examples and Comparative Examples: A substrate 20 is sent forth by a delivery device 70, and the substrate 20 sent forth is transported to a dust remover 90 as it is supported on transport rollers 80. The dust remover 90 removes dust adhering to the surface of the substrate 20. Then, a desired coating solution is applied to the dust-removed substrate by means of the coating unit 10, thereby forming a coating film. And the coating film formed is dried in a drying unit 300. Thereafter, the substrate 20 was made to pass through a heater 40, and further the coating film formed on the surface of the substrate 20 is irradiated with a UV lamp 50, thereby curing the coating film. The substrate 20 on which the desired layer is formed by the coating film being cured is taken up by means of a winder 60.

The drying unit 300 is described below in more detail. After applying a coating solution by means of amicrogravure roll measuring 50 mm in diameter and a doctor blade installed in a coating unit 10, an initial drying operation is performed with the drying unit 300 placed directly behind the coating unit 10. In the drying unit 300 are mounted nine transport rollers measuring 10 mm in diameter (transport rollers 39, 31, 32, 33, 34, 35, 36, 37 and 38). The distance between every adjacent rollers is 1 m, and the distance from the microgravure roll in the coating unit 10 to the transport roller 30 is 1 m. Additionally, each transport roller is detachable.

The drying unit 300 is equipped with a passage room 301 through which the substrate is made to pass and an exhaust room 302 for emission of the solvent vaporized. An airflow control plate 303 is disposed so as to compartmentalize the passage room 301 and the exhaust room 302. The exhaust room 302 is fitted with an exhaust pipe and an air intake pipe, and air is fed into the exhaust room 302 via the air intake pipe. The exhaust pipe and the air intake pipe are fitted on opposite sides, respectively, in the width direction of the substrate 20. As the airflow control plate 303, 300-mesh metal gauze having an aperture percentage of 30% is used. And the airflow control plate 303 is installed so as to leave a clearance of 10 mm from the surface of the coating film formed on the substrate 20. The air velocity in the passage room 301 under the experiments described hereinafter is adjusted by changing an amount of air taken in through the air intake pipe. The ambient temperature in the drying unit 300 is changed appropriately in the experiments described below. In addition, the transport speed of the substrate traveling through the passage room is also changed as appropriate in the experiments described below.

Experiments A to J were carried out by means of the model apparatus. A coating solution, a transport speed, a drying air velocity, a drying temperature and a drying rate during the solvent content reduction to 20% by mass from 45% by mass in the process of drying, which are chosen variously in every experiment, are shown in Table 1.

TABLE 1

| | | | | | Drying rate during |
|---|---|---|---|---|---|
| | | | | | solvent content |
| | | Transport | Drying air | Drying | reduction to 20 wt % |
| | Coating solution | speed | velocity | temperature | from 45 wt % |
| Experiment A | Coating solution A for | 30 m/min | 0.2 m/sec | 100° C. | 1.47 g/m² · S |
| (Example 1) | forming anti-glare hard | | | | |
| | coating layer | | | | |
| Experiment B | Coating solution A for | 30 m/min | 1.0 m/sec | 100° C. | 2.10 g/m² · S |
| (Example 2) | forming anti-glare hard | | | | |
| | coating layer | | | | |
| Experiment C | Coating solution A for | 30 m/min | 0.2 m/sec | 25° C. | 0.17 g/m² · S |
| (Comparative | forming anti-glare hard | | | | |
| Example 5) | coating layer | | | | |
| Experiment D | Coating solution A for | 10 m/min | 0.2 m/sec | 100° C. | 1.47 g/m² · S |
| (Example 3) | forming anti-glare hard | | | | |
| | coating layer | | | | |
| Experiment E | Coating solution A for | 10 m/min | 0.2 m/sec | 25° C. | 0.17 g/m² · S |
| (Comparative | forming anti-glare hard | | | | |
| Example 7) | coating layer | | | | |
| Experiment F | Coating solution B for | 20 m/min | 0.2 m/sec | 25° C. | 0.68 g/m² · S |
| (Example 4) | forming light-diffusing | | | | |
| | hard coating layer | | | | |
| Experiment G | Coating solution C for | 25 m/min | 0.2 m/sec | 25° C. | 0.25 g/m² · S |
| (Example 5) | forming low refractive | | | | |
| | index layer | | | | |
| Experiment H | Coating solution C for | 30 m/min | 0.2 m/sec | 25° C. | 0.25 g/m² · S |
| (Example 6) | forming low refractive | | | | |
| | index layer | | | | |
| Experiment J | Coating solution D for | 25 m/min | 0.2 m/sec | 25° C. | 0.25 g/m² · S |
| (Example 7) | forming low refractive | | | | |
| | index layer | | | | |

The determination of the drying rate during the solvent content reduction to 20% by mass from 45% by mass in the process of drying is described below. Although the solvent contents can be determined by measurements of mass reduced by drying for certain periods of time lapsed after coating, it is difficult to measure directly the solvent content in a coating solution on the substrate in process of being transported. Therefore, the solvent contents were estimated by off-line coating experiments made separately. In the off-line coating experiments, 18 cm×40 cm sheets were cut from a substrate first, and then put on a thermostated plate to keep them at a constant temperature. Thereafter, drops of a coating solution were put on a sheet of substrate and spread with a wire bar. After drying for every specified period of time, the decrement of mass was measured. The solvent content at the point of each transport roller was determined by the following equation:
Solvent content (% by mass) at the point of each transport roller =100−A×(B−C)/(D−C) (Equation 1)
where A is a solids content (% by mass) in the coating solution, B is the weight (g) of the substrate immediately after applying the coating solution, C is the weight (g) of the substrate before applying the coating solution, and D is the weight of the substrate after a lapse of drying time T measured from the finish of the application.

The application of a coating solution was carried out so as to adjust the total coverage to 19.9 g per m² of the substrate when the coating solution applied was a Coating Solution A for forming an anti-glare hard coating layer, 11.8 g per m² of the substrate when the coating solution applied was a Coating Solution B for forming a light-diffusing hard coating layer, and 2.3 g per m² of the substrate when the coating solution applied was a Coating Solution C or D for forming a low refractive index layer.

The solvent content data was plotted as a function of drying time t (sec.), the time at which the solvent content became 45% by mass, t_{45%}, and the time at which the solvent content became 20% by mass, t_{20%}, were read off, and the drying rate during the solvent content reduction to 20% by mass from 45% by mass was calculated by the following equation (2). In order to increase the read-off accuracy, solvent content measurements were made every 1 second during at least the time period from 1-second drying to 30-second drying.
Drying rate=(E−F)/(t_{45%}−t_{20%}) (Equation 2)

In the above equation, E is the amount of solvent (g/m²) at the time of a solvent content of 45% by mass, and F is the amount of solvent (g/m²) at the time of a solvent content of 20% by mass Herein, E and F can be calculated from the solids content in a coating solution before application and the coverage of the coating solution.

The Experiments A to J are described below in detail, and therein effects of the invention are demonstrated.

### Experiment A

### Example

A 80 μm-thick triacetyl cellulose film (TAC-TD80U, manufactured by Fuji Photo Film Co., Ltd.) in a roll form was wound off as a transparent substrate, and the Coating Solution A for forming an anti-glare hard coating layer, which was described hereinafter, was applied directly to the substrate surface in an amount of 19.9 g per m² of the substrate under a condition that the substrate was transported at a speed of 30 m/min. The application of the coating solution was performed by combined use of a doctor blade and a 50-mm-dia microgravure roll with a gravure pattern having a ruling of 135 lines per inch and a depth of 60 μm. The thus formed coating film was dried for 16 seconds at 100° C. inside the drying unit 300 wherein the air velocity in the passage room 301 was adjusted to 0.2 m/sec and the transport rollers 32 and 33 among the transport rollers 30 to 38 were detached, and thereafter it was further dried by passage through the heater 40 adjusted to 110° C. The thus dried coating film was then cured by UV irradiation with a 160 W/cm air-cooled metal halide lamp (made by Eye Graphics Co., Ltd.) at an illuminance of 400 mW/cm² and an exposure of 250 mJ/cm² under a condition of nitrogen purge, thereby forming an anti-glare hard coating layer, and the resulting film was wound up. The anti-glare hard coating layer thus formed had a thickness of 6 μm. The drying rate during the solvent content reduction to 20% by mass from 45% by mass, as measured in the off-line coating experiments, was 1.47 g/m²·s.

### Comparative Example 1

An experiment was carried out under the same conditions as in Example 1, except that the transport rollers 32 and 33 were attached.

### Comparative Example 2

An experiment was carried out under the same conditions as in Example 1, except that the transport roller 32 was attached.

### Comparative Example 3

An experiment was carried out under the same conditions as in Example 1, except that the transport roller 33 was attached.

The films obtained in Experiment A were evaluated in the following categories. Evaluation results and the solvent content at the point of each transport roller are shown in Table 2.

TABLE 2

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | Spotted | | |
| | roller | roller | roller | roller | roller | roller | roller | roller | roller | un- | | Drying |
| | 30 (1 m) | 31 (2 m) | 32 (3 m) | 33 (4 m) | 34 (5 m) | 35 (6 m) | 36 (7 m) | 37 (8 m) | 38 (9 m) | even- | Tension | air un- |
| | 53% | 47% | 38% | 27% | 19% | 15% | 11% | 8% | 5% | ness | pucker | evenness |
| Example 1 | att. | att. | detached | detached | att. | att. | att. | att. | att. | A | A | A |
| Compar. | att. | att. | att. | att. | att. | att. | att. | att. | att. | F | A | A |
| Example 1 | | | | | | | | | | | | |
| Compar. | att. | att. | att. | detached | att. | att. | att. | att. | att. | F | A | A |
| Example 2 | | | | | | | | | | | | |
| Compar. | att. | att. | detached | att. | att. | att. | att. | att. | att. | F | A | A |
| Example 3 | | | | | | | | | | | | |

Herein, “att.” is an abbreviation of attached.

(1) Evaluation of Spotted Unevenness

Whether or not spotted unevenness developed on the surfaces of wound-up hard coating film and antireflective film was observed. Specifically, a 1.34 m×1 m sheet was cut from each of the films, oil-based black ink was applied to the coating-free side of the sheet, and the extent of spotted unevenness developed on the sheet surface was visually checked by means of reflected light and evaluated on the following criterion.
A: No spotted unevenness develops at all.
B: Very faint spotted unevenness develops, but it becomes no problem in point of product quality.
F: Spotted unevenness develops to such a considerable extent that the film cannot be used as a product.
   (2) Tension Pucker

Whether or not tension puckers were left in the wound-up hard coating film and antireflective film was observed. Specifically, a 1.34 m×1 m sheet was cut from each of the films, hanged at eye level so that the coating side thereof became the front, and exposed to light. In this situation, tension puckers showing up in the direction of the length were checked visually, and the extent thereof was evaluated on the following criterion.
A: No tension pucker develops at all.
B: Very faint tension puckers develop, but they become no problem in point of product quality.
F: Tension puckers developed are so serious that the film cannot be used as a product.
   (3) Drving Air Unevenness

Whether or not drying air unevenness developed on the surfaces of wound-up hard coating film and antireflective film was observed. Specifically, a 1.34 m×1 m sheet was cut from each of the films, oil-based black ink was applied to the coating-free side of the sheet, and the extent of drying air unevenness developed on the sheet surface was visually checked by means of reflected light and evaluated on the following criterion.
A: No drying air unevenness develops at all.
B: A little drying air unevenness develops, but it becomes no problem in point of product quality.
F: Develoment of drying air unevenness is so intense that the film cannot be used as a product.

The solvent content measurement at the point of each transport roller is described below. The substrate 20 coated with a coating film travels through the downstream drying unit 300 as it was supported on the non-coated side by means of transport rollers. Since it is difficult to determine directly the solvent content in the coating film at the point of each of the transport rollers 30, 31, 32, 33, 34, 35, 36, 37 and 38 by mass measurements, solvent contents were estimated by the foregoing off-line drying experiments. Based on a distance from the coating section to each transport roller and a transport speed, the drying time T lapsed until the substrate after coating arrived at the point of each transport roller was calculated from the following equation (3), a mass decrement after drying for the drying time T was measured in the off-line coating experiment, and a solvent content was calculated using the foregoing equation (1):
Drying time T (sec)=G/H (Equation 3)
where G is a distance (m) from the coating section and a transport roller, and H is a transport speed (m/min).

### Experiment B

### Example 2

A 80 μm-thick triacetyl cellulose film (TAC-TD80U, manufactured by Fuji Photo Film Co., Ltd.) in a roll form was wound off as a transparent substrate, and the Coating Solution A for forming an anti-glare hard coating layer, which was described hereinafter, was applied directly to the substrate surface in an amount of 19.9 g per m² of the substrate under a condition that the substrate was transported at a speed of 30 m/min. The application of the coating solution was performed by combined use of a doctor blade and a 50-mm-dia microgravure roll with a gravure pattern having a ruling of 135 lines per inch and a depth of 60 μm. The thus formed coating film was dried for 16 seconds at 100° C. inside the drying unit 300 wherein the air velocity in the passage room 301 was adjusted to 1.0 m/sec and the transport roller 31 among the transport rollers 30 to 38 were detached, and thereafter it was further dried by passage through the heater 40 adjusted to 110° C. The thus dried coating film was then cured by UV irradiation with a 160 W/cm air-cooled metal halide lamp (made by Eye Graphics Co., Ltd.) at an illuminance of 400 mW/cm² and an exposure of 250 mJ/cm² under a condition of nitrogen purge, thereby forming an anti-glare hard coating layer, and the resulting film was wound up. The anti-glare hard coating layer thus formed had a thickness of 6 μm. The drying rate during the solvent content reduction to 20% by mass from 45% by mass, as measured in the off-line coating experiments, was 2.10 g/m²·s.

### Comparative Example 4

An experiment was carried out under the same conditions as in Example 2, except that the transport roller 31 was attached.

The films obtained in Experiment B were evaluated in the following categories. Evaluation results and the solvent content at the point of each transport roller are shown in Table 3.

TABLE 3

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | | | air |
| | 30 | 31 | 32 | 33 | 34 | 35 | 36 (7 m) | 37 (8 m) | 38 (9 m) | Spotted | | un- |
| | (1 m) | (2 m) | (3 m) | (4 m) | (5 m) | (6 m) | 1% or | 1% or | 1% or | un- | Tension | even |
| | 49% | 28% | 10% | 6% | 4% | 3% | below | below | below | evenness | pucker | ness |
| Example 2 | att. | detached | att. | att. | att. | att. | att. | att. | att. | A | A | A |
| Compar. | att. | att. | att. | att. | att. | att. | att. | att. | att. | F | A | A |
| Example 4 | | | | | | | | | | | | |

Herein, “att.” is an abbreviation of attached.

### Experiment C

### Comparative Example 5

A 80 μm-thick triacetyl cellulose film (TAC-TD80U, manufactured by Fuji Photo Film Co., Ltd.) in a roll form was wound off as a transparent substrate, and the Coating Solution A for forming an anti-glare hard coating layer, which was described hereinafter, was applied directly to the substrate surface in an amount of 19.9 g per m² of the substrate under a condition that the substrate was transported at a speed of 30 m/min. The application of the coating solution was performed by combined use of a doctor blade and a 50-mm-dia microgravure roll with a gravure pattern having a ruling of 135 lines per inch and a depth of 60 μm. The thus formed coating film was dried for 16 seconds at 25° C. inside the drying unit 300 wherein the air velocity in the passage room 301 was adjusted to 0.2 m/sec and the transport rollers 35 to 38 among the transport rollers 30 to 38 were detached, and thereafter it was further dried by passage through the heater 40 adjusted to 110° C. The thus dried coating film was then cured by UV irradiation with a 160 W/cm air-cooled metal halide lamp (made by Eye Graphics Co., Ltd.) at an illuminance of 400 mW/cm² and an exposure of 250 mJ/cm² under a condition of nitrogen purge, thereby forming an anti-glare hard coating layer, and the resulting film was wound up. The anti-glare hard coating layer thus formed had a thickness of 6 μm. The drying rate during the solvent content reduction to 20% by mass from45% by mass, as measured in the off-line coating experiments, was 0.17 g/m²·s.

The film obtained in Experiment C was evaluated in the following categories. Evaluation results and the solvent content at the point of each transport roller are shown in Table 4.

TABLE 4

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | Spotted | | air |
| | 30 (1 m) | 31 (2 m) | 32 (3 m) | 33 (4 m) | 34 (5 m) | 35 (6 m) | 36 (7 m) | 37 (8 m) | 38 (9 m) | un- | Tension | uneven- |
| | 54% | 53% | 51% | 48% | 46% | 43% | 40% | 38% | 35% | evenness | pucker | ness |
| Compar. | att. | att. | att. | att. | att. | detached | detached | detached | detached | A | B | F |
| Example 5 | | | | | | | | | | | | |

Herein, “att.” is an abbreviation of attached.

### Experiment D

### Example 3

A 80 μm-thick triacetyl cellulose film (TAC-TD80U, manufactured by Fuji Photo Film Co., Ltd.) in a roll form was wound off as a transparent substrate, and the Coating Solution A for forming an anti-glare hard coating layer, which was described hereinafter, was applied directly to the substrate surface in an amount of 19.9 g per m² of the substrate under a condition that the substrate was transported at a speed of 10 m/min. The application of the coating solution was performed by combined use of a doctor blade and a 50-mm-dia microgravure roll with a gravure pattern having a ruling of 135 lines per inch and a depth of 60 μm. The thus formed coating film was dried for 48 seconds at 100° C. inside the drying unit 300 wherein the air velocity in the passage room 301 was adjusted to 0.2 m/sec and the transport roller 31 among the transport rollers 30 to 38 was detached, and thereafter it was further dried by passage through the heater 40 adjusted to 110° C. The thus dried coating film was then cured by UV irradiation with a 160 W/cm air-cooled metal halide lamp (made by Eye Graphics Co., Ltd.) at an illuminance of 400 mW/cm² and an exposure of 250 mJ/cm² under a condition of nitrogen purge, thereby forming an anti-glare hard coating layer, and the resulting film was wound up. The anti-glare hard coating layer thus formed had a thickness of 6 μm. The drying rate during the solvent content reduction to 20% by mass from 45% by mass, as measured in the off-line coating experiments, was 1.47 g/m²·s.

### Comparative Example 6

An experiment was carried out under the same conditions as in Example 3, except that the transport roller 31 was attached.

Evaluation results of the films obtained in Experiment D and the solvent content at the point of each transport roller are shown in Table 5.

TABLE 5

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | | | air |
| | 30 | 31 | 32 | 33 | 34 (5 m) | 35 (6 m) | 36 (7 m) | 37 (8 m) | 38 (9 m) | Spotted | | un- |
| | (1 m) | (2 m) | (3 m) | (4 m) | 1% or | 1% or | 1% or | 1% or | 1% or | un- | Tension | even- |
| | 52% | 28% | 13% | 5% | below | below | below | below | below | evenness | pucker | ness |
| Example 3 | att. | detached | att. | att. | att. | att. | att. | att. | att. | A | A | A |
| Compar. | att. | att. | att. | att. | att. | att. | att. | att. | att. | F | A | A |
| Example 6 | | | | | | | | | | | | |

Herein, “att.” is an abbreviation of attached.

### Experiment E

### Comparative Example 7

A 80 μm-thick triacetyl cellulose film (TAC-TD80U, manufactured by Fuji Photo Film Co., Ltd.) in a roll form was wound off as a transparent substrate, and the Coating Solution A for forming an anti-glare hard coating layer, which was described hereinafter, was applied directly to the substrate surface in an amount of 19.9 g per m² of the substrate under a condition that the substrate was transported at a speed of 10 m/min. The application of the coating solution was performed by combined use of a doctor blade and a 50-mm-dia microgravure roll with a gravure pattern having a ruling of 135 lines per inch and a depth of 60 μm. The thus formed coating film was dried for 48 seconds at 25° C. inside the drying unit 300 wherein the air velocity in the passage room 301 was adjusted to 0.2 m/sec and the transport rollers 32 to 36 among the transport rollers 30 to 38 were detached, and thereafter it was further dried by passage through the heater 40 adjusted to 110° C. The thus dried coating film was then cured by UV irradiation with a 160 W/cm air-cooled metal halide lamp (made by Eye Graphics Co., Ltd.) at an illuminance of 400 mW/cm² and an exposure of 250 mJ/cm²under a condition of nitrogen purge, thereby forming an anti-glare hard coating layer, and the resulting film was wound up. The anti-glare hard coating layer thus formed had a thickness of 6 μm. The drying rate during the solvent content reduction to 20% by mass from 45% by mass, as measured in the off-line coating experiments, was 0.17 g/m²·s.

Evaluation results of the film obtained in Experiment E and the solvent content at the point of each transport roller are shown in Table 6.

TABLE 6

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | Spotted | | air |
| | 30 (1 m) | 31 (2 m) | 32 (3 m) | 33 (4 m) | 34 (5 m) | 35 (6 m) | 36 (7 m) | 37 (8 m) | 38 (9 m) | un- | Tension | uneven- |
| | 53% | 47% | 41% | 33% | 26% | 23% | 21% | 19% | 18% | evenness | pucker | ness |
| Compar. | att. | att. | detached | detached | detached | detached | detached | att. | att. | A | F | A |
| Example 7 | | | | | | | | | | | | |

Herein, “att.” is an abbreviation of attached.

### Experiment F

### Example 4

A 80 μm-thick triacetyl cellulose film (TAC-TD80U, manufactured by Fuji Photo Film Co., Ltd.) in a roll form was wound off as a transparent substrate, and the Coating Solution B for forming a light-diffusing hard coating layer, which was described hereinafter, was applied directly to the substrate surface in an amount of 11.8 g per m² of the substrate under a condition that the substrate was transported at a speed of 20 m/min. The application of the coating solution was performed by combined use of a doctor blade and a 50-mm-dia microgravure roll with a gravure pattern having a ruling of 135 lines per inch and a depth of 60 μm. The thus formed coating film was dried for 24 seconds at 25° C. inside the drying unit 300 wherein the air velocity in the passage room 301 was adjusted to 0.2 m/sec and the transport roller 31 among the transport rollers 30 to 38 was detached, and thereafter it was further dried by passage through the heater 40 adjusted to 110° C. The thus dried coating film was then cured by UV irradiation with a 160 W/cm air-cooled metal halide lamp (made by Eye Graphics Co., Ltd.) at an illuminance of 400 mW/cm² and an exposure of 250 mJ/cm² under a condition of nitrogen purge, thereby forming a light-diffusing hard coating layer, and the resulting film was wound up. The light-diffusing hard coating layer thus formed had a thickness of 3.7 μm. The drying rate during the solvent content reduction to 20% by mass from 45% by mass, as measured in the off-line coating experiments, was 0.68 g/m²·s.

### Comparative Example 8

An experiment was carried out under the same conditions as in Example 4, except that the transport roller 31 was attached. Evaluation results of the films obtained in Experiment F and the solvent content at the point of each transport roller are shown in Table 7.

TABLE 7

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | Spotted | | air |
| | 30 (1 m) | 31 (2 m) | 32 (3 m) | 33 (4 m) | 34 (5 m) | 35 (6 m) | 36 (7 m) | 37 (8 m) | 38 (9 m) | un- | Tension | uneven- |
| | 48% | 36% | 18% | 11% | 8% | 8% | 8% | 8% | 7% | evenness | pucker | ness |
| Example 4 | att. | detached | att. | att. | att. | att. | att. | att. | att. | A | A | A |
| Compar. | att. | att. | att. | att. | att. | att. | att. | att. | att. | F | A | A |
| Example 8 | | | | | | | | | | | | |

Herein, “att.” is an abbreviation of attached.

### Experiment G

### Example 5

The triacetyl cellulose film coated with the anti-glare hard coating layer which had been prepared in Example 1 was wound off again, and the coating solution C for forming a low refractive index layer as described hereinafter was applied to the hard coating layer surface in an amount of 2.3 g per m² of the film substrate under a condition that the transport speed was adjusted to 25 m/min. The application of the coating solution C was performed by combined use of a doctor blade and a 50-mm-dia microgravure roll with a gravure pattern having a ruling of 200 lines per inch and a depth of 30 μm. The thus formed coating film was dried for 19 seconds at 25° C. inside the drying unit 300 wherein the air velocity in the passage room 301 was adjusted to 0.2 m/sec and the transport roller 31 among the transport rollers 30 to 38 was detached, and thereafter it was further dried by passage through the heater 40 adjusted to 115° C. The thus dried coating film was then cured by UV irradiation with a 240 W/cm air-cooled metal halide lamp (made by Eye Graphics Co., Ltd.) at an illuminance of 400 mW/cm² and an exposure of 240 mJ/cm² under a condition of nitrogen purge, thereby forming a low refractive index layer 100 nm in thickness, and the thus prepared antireflective film was wound up. The drying rate during the solvent content reduction to 20% by mass from 45% by mass, as measured in the off-line coating experiments, was 0.25 g/m²·s.

### Comparative Example 9

An experiment was carried out under the same conditions as in Example 5, except that the transport roller 31 was attached.

Evaluation results of the films obtained in Experiment G and the solvent content at the point of each transport roller are shown in Table 8.

TABLE 8

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | Spotted | | air |
| | 30 (1 m) | 31 (2 m) | 32 (3 m) | 33 (4 m) | 34 (5 m) | 35 (6 m) | 36 (7 m) | 37 (8 m) | 38 (9 m) | un- | Tension | uneven- |
| | 85% | 21% | 12% | 10% | 8% | 7% | 7% | 7% | 7% | evenness | pucker | ness |
| Example 5 | att. | detached | att. | att. | att. | att. | att. | att. | att. | A | A | A |
| Compar. | att. | att. | att. | att. | att. | att. | att. | att. | att. | B | A | A |
| Example 9 | | | | | | | | | | | | |

Herein, “att.” is an abbreviation of attached.

### Experiment H

### Example 6

An experiment was performed under the same conditions as Example 5, except that the transport speed was changed to 30 m/min and the drying time in the drying unit 300 was adjusted to 16 seconds.

### Comparative Example 10

Another experiment was carried out under the same conditions in Example 6, except that the transport roller 31 was attached.

Evaluation results of the films obtained in Experiment H the solvent content at the point of each transport roller are shown in Table 9.

TABLE 9

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | Spotted | | air |
| | 30 (1 m) | 31 (2 m) | 32 (3 m) | 33 (4 m) | 34 (5 m) | 35 (6 m) | 36 (7 m) | 37 (8 m) | 38 (9 m) | un- | Tension | uneven- |
| | 86% | 43% | 13% | 12% | 10% | 9% | 9% | 7% | 7% | evenness | pucker | ness |
| Example 6 | att. | detached | att. | att. | att. | att. | att. | att. | att. | A | A | A |
| Compar. | att. | att. | att. | att. | att. | att. | att. | att. | att. | F | A | A |
| Example | | | | | | | | | | | | |
| 10 | | | | | | | | | | | | |

Herein, “att.” is an abbreviation of attached.

### Experiment J

### Example 7

An experiment was performed under the same conditions as in Example 5, except that the coating solution was changed to the coating solution D for forming a low refractive index layer as described hereinafter and the substrate to be coated was changed to the light-diffusing hard coating layer formed in Example 4.

Evaluation results of the film prepared in Experiment J and the solvent content at the point of each transport roller are shown in Table 10.

TABLE 10

| | Indication as to whether or not each transport roller was detached | | | | | | | | | | | |
|---|---|---|---|---|---|---|---|---|---|---|---|---|
| | and Solvent content at the point of each transport roller | | | | | | | | | | | |
| | (Value put in each parentheses is a distance from the coating section) | | | | | | | | | Evaluation categories | | |
| | Transport | Transport | Transport | Transport | Transport | Transport | Transport | Transport | Transport | | | Drying |
| | roller | roller | roller | roller | roller | roller | roller | roller | roller | Spotted | | air |
| | 30 (1 m) | 31 (2 m) | 32 (3 m) | 33 (4 m) | 34 (5 m) | 35 (6 m) | 36 (7 m) | 37 (8 m) | 38 (9 m) | un- | Tension | uneven- |
| | 85% | 21% | 12% | 10% | 8% | 7% | 7% | 7% | 7% | evenness | pucker | ness |
| Example 7 | att. | detached | att. | att. | att. | att. | att. | att. | att. | A | A | A |

Herein, “att.” is an abbreviation of attached.

Preparation methods and compositions of the coating solutions used are described below.

(Preparation of Coating Solution A for Forming Anti-glare Hard Coating Layer)

A mixture of pentaerythritol triacrylate and pentaerythritol tetraacrylate (PET-30, produced by Nippon Kayaku Co., Ltd.) in an amount of 50 kg was diluted with 38.5 kg of toluene and 31.7 kg of cyclohexanone. Thereto, 2 kg of a polymerization initiator (Irgacure 184, produced by Ciba Specialty Chemicals) was further added and stirred. To the resulting solution were furthermore added 1.5 kg of a 30% toluene dispersion of cross-linked polystyrene particles having an average particle size of 3.5 μm (refractive index: 1.60, SX-350, produced by Soken Chemical & Engineering Co., Ltd.) and 13.0 kg of a 30% toluene dispersion of cross-linked acrylic-styrene particles having an average particle size of 3.5 μm (refractive index: 1.55, produced by Soken Chemical & Engineering Co., Ltd.), which were each prepared by 20 minutes' dispersion at 10,000 rpm by means of a Polytron dispersing machine. Finally thereto were added 0.75 kg of a fluorine-containing surface modifier (FP-132) represented by the following chemical formula and 10 kg of a silane coupling agent (KBM-5103, produced by Shin-Etsu Chemical Co., Ltd.), thereby yielding a finished solution.

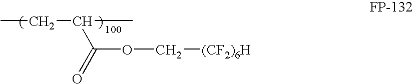

The mixed solution thus obtained was passed through a polypropylene filter having a pore size of 30 μm to prepare the Coating Solution A for forming an anti-glare hard coating layer.

The solids concentration in the Coating Solution A for forming an anti-glare hard coating layer was 45% by mass (solvent content: 55% by mass).

(Preparation of Coating Solution B for Forming Light-diffusing Hard Coating Layer)

Desolite Z7404 (a solution of hard coating composition containing zirconia fine particles, produced by JSR Corporation) in an amount of 100 kg was mixed with 31 kg of a mixture of dipentaerythritol pentaacrylate and dipenaerythritol hexaacrylate (DPHA, produced by Nippon Kayaku Co., Ltd.). To this mixed composition were added 11.3 kg of a 30% methyl isobutyl ketone dispersion of cross-linked acrylate particles 3.5 μm in size (refractive index: 1.49, MXS-300, produced by Soken Chemical & Engineering Co., Ltd.) and 29.7 kg of a 30% methyl isobutyl ketone dispersion of 1.5-μm silica particles, which were each prepared in advance by 3hours' dispersion at 5,000 rpm by means of a Polytron dispersing machine. Finally thereto were added 20.7 kg of methyl ethyl ketone, 23.9 kg of methyl isobutyl ketone and 10 kg of a silane coupling agent (KBM-5103, produced by Shin-Etsu Chemical Co., Ltd.), thereby yielding a finished solution.

The mixed solution thus obtained was passed through a polypropylene filter having a pore size of 30 μm to prepare the Coating Solution B for forming a light-diffusing hard coating layer.

The solids concentration in the Coating Solution B for forming a light-diffusing hard coating layer was 50% by mass (solvent content: 50% by mass).

(Preparation of Sol a)

In a reaction vessel equipped with a stirrer and a reflux condenser, 120 parts of methyl ethyl ketone, 100 parts of acryloyloxypropyltrimethoxysilane (KBM5103, tradename, a product of Shin-Etsu Chemical Co., Ltd.) and 3 parts of diisopropoxyaluminum ethylacetoacetate were put, and mixed. Then, the resulting mixture was admixed with 30 parts of ion-exchanged water, and underwent reaction for 4 hours at 60° C. Thereafter, the reaction solution was cooled to room temperature to give a sol a. The mass-average molecular weight of the sol a was found to be 1,800, and all the components having higher molecular weight than oligomer components had their molecular weights in the range of 1,000 to 20,000. Further, it was ascertained by gas chromatographic analysis that the acryloyloxypropyltrimethoxysilane used as a starting material didn't remain at all.

(Preparation of Coating Solution C for Forming Low Refractive-index Layer)

To 30 kg of a solution of thermally cross-linkable fluorine-containing polymer having a refractive index of 1.44 (JTA113B, solids concentration: 6%, main solvent: methyl ethyl ketone, produced by JSR Corporation), 6.1 kg of methyl ethyl ketone, 1.2 kg of cyclohexanone, 3.1 kg of 45-nm particulate silica dispersion (MEK-ST-L, solids concentration: 30%, main solvent: methyl ethyl ketone, produced by Nissan Chemical Industries, Ltd.) and 1.5 kg of the sol a were added, and stirred. Then, the mixture was passed through a polypropylene filter having a pore size of 1 μm, thereby preparing a coating solution for forming a low refractive-index layer.

The solids concentration of the Coating Solution C thus prepared for a low refractive-index layer was found to be 7.6% by mass (solvent content: 92.4% by mass).

(Preparation of Coating Solution D for Forming Low Refractive-index Layer)

To 30 kg of a solution of thermally cross-linkable fluorine-containing polymer having a refractive index of 1.42 (JN7228A, solids concentration: 6%, main solvent: methyl ethyl ketone, produced by JSR Corporation), 2.8 kg of methyl ethyl ketone, 1.1 kg of cyclohexanone, 1.5 kg of 45-nm particulate silica dispersion (MEK-ST-L, solids concentration: 30%, main solvent: methyl ethyl ketone, produced by Nissan Chemical Industries, Ltd.), 1.3 kg of 12-nm particulate silica dispersion (MEK-ST, solids concentration: 30%, main solvent: methyl ethyl ketone, produced by Nissan Chemical Industries, Ltd.) and 0.6 kg of the sol a were added, and stirred. Then, the mixture was passed through a polypropylene filter having a pore size of 1 μm, thereby preparing a coating solution D for forming a low refractive-index layer.

The solids concentration of the Coating Solution D for a low refractive-index layer was found to be 7.6% by mass (solvent content: 92.4% by mass).

The following are clarified by the results shown in Tables 2 to 10.

No spotted unevenness develops when a transport roller or transport rollers situated in a zone where the solvent content in a coating film on a substrate comes to range from 45% to 20% by mass by the solvent becoming concentrated as a result of vaporization in the process of drying are detached in advance, and thereby the substrate is kept from contact with that or those transport rollers in the above-specified range of solvent content.

On the other hand, spotted unevenness developed in cases where the substrate was brought into contact with and passed over a transport roller or transport rollers when the solvent content was in the above-specified range. As are as on for this unevenness, it is supposed that, when the substrate comes into contact with a transport roller, microscopic asperities on the transport roller surface (which cannot be perceived by visual observation) cause temperature differences in microscopic areas in a coating film on the substrate and thereby solvent movements by concentration gradient occur to result in spotted unevenness of film thickness.

As long as the solvent content is higher than 45% by mass, no spotted unevenness develops even when the non-coated side of a substrate is brought into contact with a transport roller. Since a coating film rich in solvent has a leveling effect, no unevenness is thought to be caused therein. Even when the solvent content is lower than 20% by mass, on the other hand, spotted unevenness does not develop by a contact between a transport roller and the non-coated side of a substrate. As a reason for such a phenomenon, it is thought that solvent movements are hard to occur since the consistency of a coating film is increased with a decrease in remaining quantity of solvent.

Drying at a slow rate as in Comparative Example 7 increases the number of transport rollers to be detached because of their locations in the zone where the solvent content falls in the range of 20% to 45% by mass, and thereby the distance to be transported in a non-contact state becomes long. As a result, tension puckers develop in the transport direction though spotted unevenness can be avoided. Such puckers are thought to be caused by a long-distance transport of the substrate under a tension in the transport direction without being supported by any transport rollers in the width direction.

### Example 8

A 80 μm-thick triacetyl cellulose film (TAC-TD80U, manufactured by Fuji Photo Film Co., Ltd.), which had undergone sequentially 2 minutes' immersion in a 55° C. water solution containing 1.5 mol/L of NaOH, neutralization and washing with water, and the present sample prepared in Example 5 (the present antireflective film saponified in advance) were laminated on both sides of a polarizing film formed by making polyvinyl alcohol adsorb iodine and stretching it into film, thereby protecting the polarizing film on both sides respectively. The thus made polarizing plate was laminated so that the antireflective film was situated in the uppermost position in place of the viewer-side polarizing plate included in the liquid crystal display of a transmission TN liquid crystal display-equipped notebook PC (having a polarization split film with a polarization select layer, D-BEF (made by Sumitomo 3M), between a backlight and liquid crystal cells). As a result, background reflections in the display were extremely reduced, and the display unit 300 with very high display quality was obtained.

### Example 9

A PVA film was immersed in a water solution containing 2.0 g/l of iodine and 4.0 g/l of potassium iodide for 240 seconds at 25° C., further immersed in a water solution containing 10 g/l of boric acid for 60 seconds at 25° C., and then introduced into a tenter stretching machine having the configuration illustrated in FIG. 2 of JP-A-2002-86554. Therein, the film was stretched to 5.3 times its original dimensions, and the tenter was bent toward the stretching direction as shown in the FIG. 2, and thereafter the film width was kept constant. After drying in the atmosphere of 80° C., the film was made to leave the tenter. The transport speed difference between both tenter clips was smaller than 0.05%, and the angle between the center line of the film introduced and that of the film sent to the next process was 46°. Herein, |L1−L21| was 0.7 m and W was 0.7 m, so there was a relation of |L1−L21|=W. The substantial stretch direction at the tenter exit, Ax-Cx, was inclined 45° toward the center line of the film sent to the next process. At the tenter exit, neither wrinkle nor film deformation was observed.

Further, the film thus stretched was laminated with a saponified cellulose triacetate film (Fuji TAC, manufactured by Fuji Photo Film Co., Ltd., retardation value: 3.0 nm) by using a 3% water solution of PVA (PVA-117H, produced by Kuraray Co., Ltd.) as an adhesive, and further dried at 80° C., thereby obtaining a polarizing plate having an effective width of 650 mm. The direction of the absorption axis of the polarizing plate obtained was inclined 45° toward the direction of the length. This polarizing plate had a transmittance of 43.7% at 550 nm, and a polarization degree of 99.97%. Further, this plate was cut into plates measuring 310×233 mm in size, thereby giving polarizing plates having an absorption axis inclined 45° toward each edge with an area efficiency of 91.5%.

Then, the thus prepared polarizing plate was laminated with the present sample prepared in Example 5 (the antireflective film saponified in advance), thereby making a polarizing plate provided with antireflection. A liquid crystal display unit made by using this polarizing plate so that its antireflective layer was situated on the uppermost position had no reflection of-external light, and delivered high contrast, unremarkable reflection images and excellent viewability.

### Example 10

When optical compensation films (Wideview Film Ace, manufactured by Fuji Photo Film Co., Ltd.) were used respectively as a protective film on the liquid crystal cell side of the polarizing plate laminated with the present antireflective film of Example 5 and situated on the viewer side of a transmission TN liquid crystal cell and a protective film on the liquid crystal cell side of a polarizing plate situated on the backlight side, the liquid crystal display unit obtained had high contrast in a lighted room, very wide viewing angles in both vertical and lateral directions, outstanding viewability and high display quality.

The present film prepared in Example 7 had a light-diffusing property that the intensity of light scattered at the angle of with respect to the exit angle of 0° was 0.06%. The liquid crystal display using this film was improved in viewing angle in the downward direction and reduced in yellow tint in the lateral direction owing to the light-diffusing property mentioned above. As compared to that film, the film prepared in the same method as in Example 6, except that the cross-linked PMMA particles and the particulate silica were removed from the Coating Solution B for forming the light-diffusing hard coating layer, had a light-diffusing property that the intensity of light scattered at the angle of 30° with respect to the exit angle of 0° was substantially 0% and the liquid crystal display using this film had neither increase in viewing angle in the downward direction nor improvement in yellow tint.

### Example 11

A 80 μm thick cellulose acylate sample 201 was prepared using cellulose acylate having an acetyl substitution degree of 2.94% an optical anisotropy lowering agent A-19 in a proportion of 49.3% (to the cellulose acylate) and a wavelength dispersion controlling agent UV-102 in a proportion of 7.6% (to the cellulose acylate) in accordance with the same film formation method as in Example 5. The retardation Re of the film obtained was −1.0 nm (which was negative because the film had its slow axis in the TD direction) and the retardation Rth in the thickness direction was −2.0 nm. In other words, both retardation values were small. By using this cellulose acylate film sample as a transparent substrate of the cell-side protective film of two protective films for a polarizer and the present film prepared in Example 1 as a protective film on the viewer-side of the polarizer, quality evaluations of the present film were made on the liquid crystal display unit described in Example 1 of JP-A-10-48420, the liquid crystal display unit provided with the optically anisotropic layer containing discotic liquid crystal molecules described in Example 1 of JP-A-9-26572, the VA-mode liquid crystal display units illustrated in FIGS. 2 to 9 of JP-A-2000-154261 and the OCB-mode liquid crystal display units illustrated in FIGS. 10 to 15 of JP-A-2000-154261. In every case, good performances were delivered with respect to contrast and viewing angle. 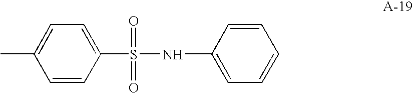
Wavelength dispersion controlling agent UV-102

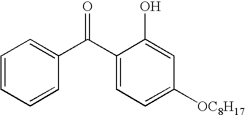

### Example 12

When the present film prepared in Example 5 was laminated on the surface glass sheet of an organic EL display with the aid of a pressure-sensitive adhesive, reflections from the glass surface were inhibited and the display with high viewability was obtained.

### Example 13

A polarizing plate provided with an antireflective film on one side was formed by use of the present film prepared in Example 5, and laminated with a λ/4 plate on the side opposite to the antireflective film side. When the resulting polarizing plate was laminated on the surface glass plate of an organic EL display so that the antireflective film side was situated in the uppermost position, surface reflections and reflections from the interior of the surface glass were cut down, thereby ensuring display with very high viewability.

According to the present drying method, unevenness developing in the process of drying can be prevented without modifying physical properties of a coating solution to be applied and making any considerable alterations to a drying unit to be used, and coating films can be dried in a good surface condition with efficiency; as a result, high manufacturing efficiency can be achieved. Further, optical films and antireflective films having coating films formed using the present drying method can deliver performances requisite for them without impairment thereof.

The entire disclosure of each and every foreign patent application from which the benefit of foreign priority has been claimed in the present application is incorporated herein by reference, as if fully set forth.

What is claimed is:

1. A method of drying a coating film comprising:
applying a coating solution containing a solvent to a continuously-transporting substrate so as to form a solvent-containing coating film; and
drying the solvent-containing coating film,
wherein, when the coating film includes an area having a solvent content in a range of 20% to 45% by mass, the area of the coating film is dried at a rate of 0.2 g/m²·s or above, and a portion of the substrate, on which the area of the coating film is formed, is transported in a non-contact state.

2. A method of drying as described in claim 1,
wherein the drying rate is from 0.25 g/m²·s to 3.00 g/m²·s.

3. A method of drying as described in claim 1,
wherein the area of the coating film is dried at a temperature between 25° C. and 120° C.

4. A method of drying as described in claim 1,
wherein the area of the coating film is dried at an air velocity of 0.1 m/sec to 1.5 m/sec.

5. A method of drying as described in claim 1,
wherein a transport distance of the area of the substrate in the non-contact state is 3 m or below.

6. A method of drying as described in claim 1,
wherein the solvent is an organic solvent selected from ketones or aromatic hydrocarbons.

7. A method of drying as described in claim 1,
wherein the coating solution is a coating solution for forming an optically functional layer.

8. A method of drying as described in claim 7,
wherein the coating solution for forming an optically functional layer is a coating solution for forming an anti-glare hard coating layer.

9. A method of drying as described in claim 7,
wherein the coating solution for forming an optically functional layer is a coating solution for forming a light-diffusing hard coating layer.

10. A method of drying as described in claim 7,
wherein the coating solution for forming an optically functional layer is a coating solution for forming a layer with a low refractive index.

11. An optical film having a layer formed by use of a method of drying as described in claim 1.

12. An antireflective film prepared by imparting an antireflective property to an optical film as described in claim 11.
